(19) United States
(12) Patent Application Publication
(10) Pub. No.: US 2008/0224500 A1
(43) Pub. Date: Sep. 18, 2008

(54) Vehicle Body Composed Of At Least Two Prefabricated Modules, And Method For The Production Thereof

(75) Inventors: Lothar Patberg, Moers (DE); Mario Schmidt, Moers (DE)

Correspondence Address: PROSKAUER ROSE LLP, ONE INTERNATIONAL PLACE, BOSTON, MA, 02110, US

(73) Assignee: ThyssenKrupp Steel AG, Duisbury (DE)

(21) Appl. No.: 12/089,290

(22) PCT Filed: Oct. 4, 2006
(86) PCT No.: PCT/EP2006/067049

§ 371 Date: Jun. 4, 2008

(30) Foreign Application Priority Data
Oct. 6, 2005 (DE) 10 2005 047 927.8

(51) Int. Cl. B62D 27/00; F16B 11/00

(52) U.S. Cl. 296/193.01; 403/375

(57) ABSTRACT

A motor vehicle body can be manufactured economically and assembled without any problem from prefabricated modules. This is resolved in that the modules are connected to one another in a non-detachable manner in a joint zone, such that a sheet of the one module coming into contact in the joint zone on a sheet section of another module, are joined to one another in a joining process, in which at least one of the sheet sections has been cold-formed, with positive and/or non-positive fit, and in that in at least one of the modules an access channel is formed, extending at least in sections along the joint zone and accessible from outside for introduction of a joining tool.

### CROSS-REFERENCE TO RELATED APPLICATIONS

This application is a National Phase Application of International Application No. PCT/EP2006/067049, filed on Oct. 4, 2006, which claims the benefit of and priority to German patent application no. DE 10 2005 047 927.8-21, filed Oct. 6, 2005. The disclosure of each of the above applications is incorporated herein by reference in their entirety.

### FIELD OF THE INVENTION

The invention relates to a motor vehicle body, which is assembled from at least two prefabricated modules, and to a method for manufacturing such a motor vehicle body.

### BACKGROUND

There is growing demand in the sector of body construction for the lowest possible weight with, at the same time, optimized deformation behavior in the event of an accident. The reduced body weight makes lower energy consumption possible for the drive system of the motor vehicle concerned. Through optimized crash behavior, the users of the motor vehicle are given optimum protection in the event of an accident.

A further requirement in the motor vehicle body sector with regard to economical manufacture is that the individual modules of the motor vehicle which is to be manufactured should be presented as far as possible as completely finished before being assembled to form the finished motor vehicle. Due to separate manufacture beforehand, simplified assembly of the individual parts of each module is possible, making use of optimized procedures.

The demands placed on a motor vehicle body in respect of its weight and deformation behavior can be optimally fulfilled by modules made of light metal or plastic elements being combined with modules made of steel or plastic. The selection of the suitable material for the particular element is made in this context as a function of the loads which take effect on the component concerned in practical operation.

Making use of this inherently known principle, it has been proposed, for example, that with a private car the front part of the motor vehicle accommodating the drive unit elements and the front axle are prefabricated as a complete module from a light metal material, while the passenger compartment is made from high-strength steel materials. Because the different materials cannot as a rule be welded to one another, the modules made of incompatible materials are usually bolted, riveted or adhesively bonded to one another. In this context, these types of connection are also used in combination in order to guarantee the required strength of the connection even under the dynamic forces which occur in practical operation.

A disadvantage in this situation is the fact that elaborate design and technical manufacturing measures are required in order to be able to manufacture in this way body construction elements which are sufficiently rigid to meet today's requirements. It has also been shown that if it is intended, for example, that the individual modules should be adhesively bonded to one another, substantial quantities of adhesive are required, which on the one hand reduce the weight advantage achieved by the use of lightweight materials for the construction of the modules and, on the other, can only be applied with greater effort of time and equipment than with conventional manufacture.

Regardless of whether the prefabricated modules are connected to one another in a known manner by welding, bolting, riveting, bonding, or another of the methods referred to heretofore, there is the problem that either limits are set on the degree of prefabrication due to the joining method applied in the particular case or the work required for joining the modules is so complex that the advantages of prefabrication are nullified. Thus, modules which are intended to be welded together to the body as a whole must not be attached to sensitive structural elements or painted in areas which are subjected to heat produced during welding. In addition to this, connecting body modules by bolting or riveting, in the same way as welding or bonding, requires as a precondition adequate accessibility of the individual assembly points.

### SUMMARY OF THE INVENTION

In general, one aspect of the invention is to create a motor vehicle body which is economical to manufacture and can be assembled from prefabricated modules with no problem. In addition to this, a method for manufacturing such a motor vehicle body should also be described.

With regard to a motor vehicle body which is assembled from at least two prefabricated modules, this aspect is resolved in that the modules are connected to one another in a non-detachable manner in a joint zone, such that a sheet of one module coming into contact in the joint zone on a sheet section of another module are joined to one another in a joining process, in which at least one of the sheet sections has been cold-formed, with positive and/or non-positive fit, and in that in at least one of the modules an access channel is formed, extending at least in sections along the joint zone and accessible from outside for introduction of a joining tool.

In a corresponding manner, the aspect mentioned above is resolved with reference to a method for manufacturing a motor vehicle body formed according to the invention in that the following production steps are followed:
a) Prefabrication of the modules including the formation of sheet sections allocated to one another in the joint zone,
b) Alignment of the modules in such a way that the sheet sections allocated to one another abut on one another in the joint zone,
c) Cold-forming of at least one of the sheet sections abutting on one another in such a way that, after cold-forming, the sheet sections are connected to one another in a non-detachable manner in positive and non-positive fit.

According to the invention, the modules of the motor vehicle body, which in particular can be a body for a private car, are first prefabricated in a known manner. The prefabricated modules are then joined according to the invention by a joining process carried out cold, in such a way that they are connected to one another in a non-detachable manner. Joining of the individual modules in this situation is carried out as cold-forming of at least one of the sheets of the modules abutting on one another. Additional connection elements, such as bolts, rivets or the like are not required for this.

In order to be able to carry out the joining of the modules in the manner according to the invention to form a total body easily and with low technical manufacturing effort and expenditure, the individual modules of a motor vehicle body according to the invention are designed in such a way that, as appropriate, they form, individually or together in the assembled state, in the area of the joint zones, channels by means of which a tool required for the cold-forming can be moved in the joint zone.

While as the invention proposes on the one hand that the individual prefabricated modules of a motor vehicle body according to the invention should be connected to one another by cold-forming, and, on the other, that the motor vehicle body should be designed in such a way that simplified access to the body is guaranteed precisely in the areas in which the cold-forming must be carried out, a connection concept is provided which makes it possible, in a manner simple to implement, for modules which to a large extent are prefabricated and fitted with complex and sensitive components to be reliably connected to form a motor vehicle body. Thus, according to the invention, it is possible even for ready-painted and fully-equipped modules to be joined to form a motor vehicle body according to the invention.

According to an embodiment of the invention with regard to its practical implementation, provision is made for the joint zone and the access channel extending along it to be designed in a straight line. Such a straight line embodiment makes it particularly simple to move the tools required for the cold-forming into the area of the joint zone.

The advantages of the invention already make themselves apparent in the manufacture of bodies which are manufactured from materials of one single class of material. Thus, for example, the manner according to the invention of joining prefabricated modules to form a body also has a particularly positive effect if ready prefabricated and fitted modules made of steel are intended to be joined to form a motor vehicle body consisting overall of steel materials. Beyond this, however, the invention is particularly well-suited also for such applications in which the first module of the motor vehicle body consists, at least in its section coming into contact directly with the second module, of a material which belongs to another class of material than the material of the section of the second module with which it comes into contact. Thus, in the manner according to the invention, modules made of plastic material, light metal and steel can be connected to one another without any problem.

One embodiment of the invention which is particularly well-suited for practical and large-scale technical implementation is characterized in that the positive and non-positive connection between the sheet sections is formed in such a way that a peripheral section of the first module is placed in a securing slot formed into the second module and is held in the securing slot in positive and/or non-positive fit by means of material of the second module pressed laterally onto the peripheral section of the first module placed in the securing slot.

One embodiment of the method according to the invention which is particularly well-suited to the manufacture of this variant of a body according to the invention is characterized in that the production step a) comprises the formation of a securing slot on a sheet section of the one module (i.e., a second module) and a strip-like freely-projecting peripheral section on the other module (i.e., a first module), the course of which is adapted to the course and shape of the securing slot, in that the production step b) comprises the insertion of the peripheral section of the first module into the securing slot of the second module, and in that the production step c) comprises the pressing of material of the second module laterally adjacent to the securing slot against the peripheral section of the first module located in the securing slot, such that the two modules are connected to one another in a non-detachable manner in non-positive and/or positive fit at least over specific longitudinal sections of the securing slot.

According to this embodiment of the invention, the method already known from EP 0 868 237 B1 for the manufacture of metal profiles is now also used for connecting prefabricated modules to form a motor vehicle body. This known method makes provision for the minimum of two parts of a metal profile to be connected to one another exclusively by clamping force. The manufacture of the known metal profiles in this situation is carried out in such a way that a slot is firstly formed into one of the parts which are to be joined. With this formation, a change occurs in the joining in the more immediate vicinity of the slot. Next, another part consisting of flat material is inserted with its narrow side into this slot and clamped tight in the slot by crushing the material in the first part, which is adjacent to the slot. In this situation, a further change in the joining takes place, such that an exclusively non-positive and positive connection is created between the two adjacent parts. In this way, parts made of any desired metals can be joined for which the other joining techniques are not well-suited or optimum, whether this is due to the material combination or for other reasons.

Because of the demands put on the cold-forming properties of the parts being joined together, those motor vehicle bodies are particular well-suited for application of the variant of the invention referred to heretofore in which at least the section of the second module, into which the securing slot is formed, consists of a metal material. Because of their good deformation properties, steel materials are particularly well-suited for this purpose. Likewise, however, light metal materials, such as magnesium or aluminium materials, can be used as the construction material for the second module, provided with the securing slot, if these allow for the forces taking effect on the particular module in practical operation.

Depending on the particular local circumstances, the type of connection for the modules used according to the invention can be created in a particularly simple manner if the peripheral section of the first module placed in the securing slot is aligned essentially perpendicular to the surface of the section of the second module, into which the securing slot is formed.

Inasmuch as, the modules form a hollow profile after joining in the connection area, which is delimited at the sides by at least two mutually opposing walls, of which in each case a part is allocated to the second module, it is advantageous from a technical manufacturing point of view if the one part of the wall has a cropped peripheral section, in the surface of which, allocated to the first module, the securing slot is formed, while the other part of the walls in each case is allocated to the first module and is held by its peripheral section in the securing slot. With this embodiment, the individual modules to be connected to one another have, before joining in the connection area, open profile sections, into which the tool used to apply the required pressure forces can be introduced without any problem.

Such a tool can, for example, be designed in such a way that with production step c) the forces required for pressing the material of the second module against the peripheral section of the first module are applied by means of two pressure rollers moved along securing slot, of which in each case one is guided on one of the sides of the securing slot and at a short distance from it.

As an alternative to the variant of the method according to the invention explained heretofore, which makes use of the possibility known from EP 0 868 237 B1 of connecting two sheet parts, it is also conceivable for cold-forming of the sheet sections abutting on one another to be carried out as a peripheral flanging process.

### BRIEF DESCRIPTION OF THE DRAWINGS

The invention is explained in greater detail hereinafter on the basis of a drawing representing an embodiment. The figures represent in diagrammatic form:

FIG. 1 A motor vehicle body for a private car in a side view;

FIG. 2 A section along the intersection line A-A inserted in FIG. 1;

FIG. 3 A section along the intersection line B-B inserted in FIG. 1.

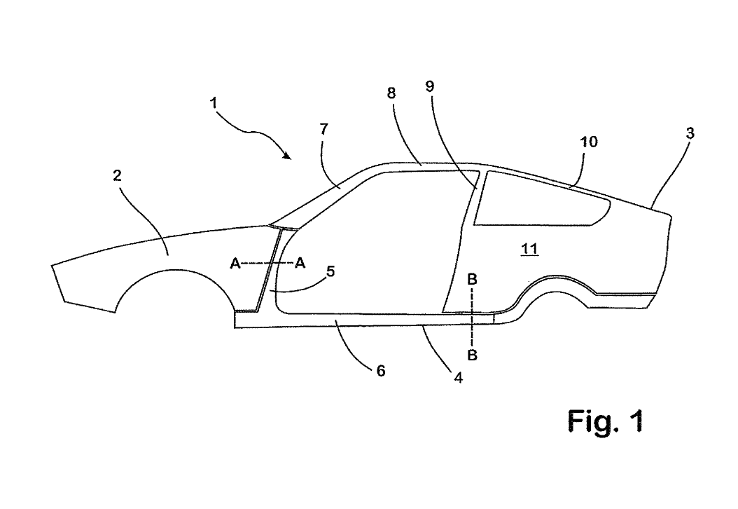

### DESCRIPTION

The motor vehicle body 1 is composed of three modules 2, 3, 4, of which the module 2 forms the front part of the motor vehicle, the module 3 a side part and the module 4 the floor section, including the A-column 5 and the outside sill 6 of the motor vehicle body. When the motor vehicle is completely assembled, the module 2 forming the front part of the motor vehicle carries the entire drive train of the motor vehicle, while the passenger compartment of the motor vehicle body 1 consists of the module 3 (side part) and the module 4 (floor section), a module forming the roof of the motor vehicle body 1, not shown here, and a side part module, likewise not visible here.

In order to achieve the lowest possible weight, the module 2 is composed of sheet parts, not represented here individually, which in each case are manufactured from an aluminium material. The connection of the sheet parts of the first module 2 to one another was carried out in a conventional manner by welding. The overall structure of the module 2 in this situation has been designed in such a way that it is capable of accommodating the loads arising in operation with adequate rigidity and at the same time has an optimized energy absorption capacity in the event of an accident.

The module 4 forming the floor section of the motor vehicle body 1, by contrast, is manufactured from a high-strength lightweight steel material which, due to its strength and shaping, ensures that the passenger compartment of the motor vehicle body 1 provides optimum protection for the occupants even in the event of an accident and in normal operation provides high overall rigidity of the motor vehicle body 1.

The module 3 forming the side part is manufactured from a base frame, which is composed of steel sheets welded to one another and, inter alia, comprises the front roof column 7, connected to the A-column 5 of module 4, the roof carrier 8, the B-column 9 and the C-column 10 of the motor vehicle body 1, and plastic surface elements 11 which fill the side surfaces of the module 3 encompassed by the basic frame.

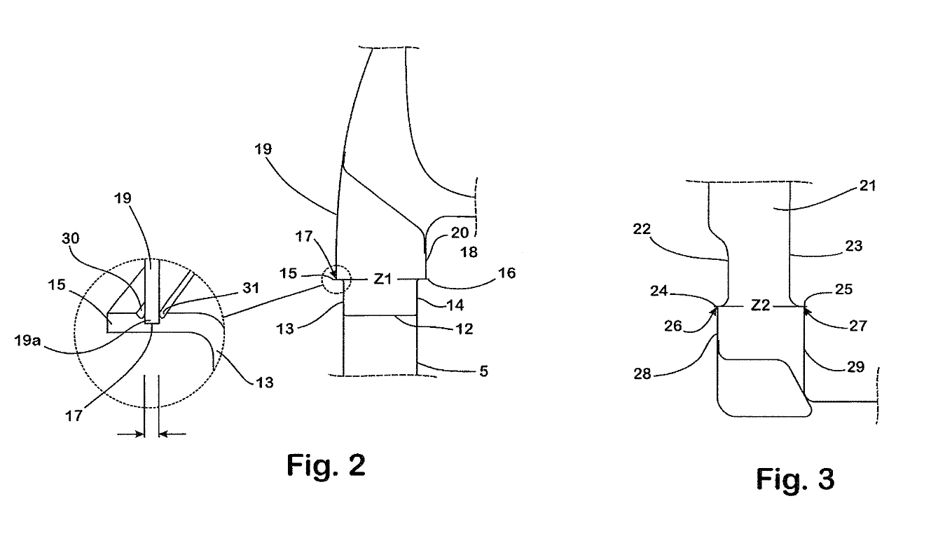

The module 2 and the module 4 are, inter alia, connected to one another in the area of the A-column 5 of the module 4 in non-positive and positive fit (FIG. 2). For this purpose, the A-column 5 is formed from a steel sheet part 12, shaped in the manner of a U-profile, the blades 13, 14 of which are oriented in the direction of the module 2. At the free ends of the blades 13, 14, there are in each case at right angles from the blades 13, 14 narrow sections 15, 16, cropped off, pointing outwards, in the surface of which, allocated to the module 2, in each case a securing slot 17, 18, is formed, extending along the blades 13, 14.

Formed at the module 2, in the area connected to the module 4, are in each case wall sections 19, 20, which project in the direction of the steel sheet part 12 of the module 4 and are arranged and aligned in such a way that, after joining of the modules 2, 4, in each case a wall section 19, 20 stands with its free peripheral area 19a in one of the securing slots 17 or 18 respectively. In the state intended for joining, the wall sections 19, 20 of the module 4, contacting the blades 13, 14 of the module 2, with the blades 13, 14 in the area of the joint zone determined more specifically by the securing slots 17, 18, enclose an access channel Z1, freely accessible from outside, through which the tool required for the subsequent cold-forming operation, not represented here, can be guided along the securing slots 17, 18. After pressing of the material adjacent to the securing slots 17, 18 with the aid of this tool the wall section 19, 20 placed in each case in the securing slot 17, 18 concerned is held there in a non-detachable manner in positive and non-positive fit. After forming and removal of the tool, the opening of the access channel Z1 can be closed by means of a cap.

In order to connect the module 4 to the module 3 in the area of the outer sill 6, the steel sheet element 21 belonging to the base frame of the module 3 and attached directly at the outer sill 6, is formed as an U-profile, whose open part is directed to the outer sill 6. At the free blades 22, 23 of this steel sheet element 21, in the same way as with the A-column 5, narrow sections 24, 25 pointing outwards are cropped off, into which in each case a securing slot 26, 27 is formed, by means of which a further joint zone is defined.

The outer sill 6 has in this area wall sections 28, 29 projecting freely in the direction of the module 3, which are arranged and orientated in such a way that, after joining of the modules 3, 4, in each case a wall section 28, 29 stands with its free peripheral area in one of the securing slots 26 or 27 respectively of the steel sheet element 21 of the module 3. The wall sections 28, 29 of the outer sill 6 also, and the free blades 22, 23 of the steel sheet element 21 contacting them, in the state intended for joining, enclose an access channel Z2, accessible from outside, into which in turn the tool can be introduced which is necessary for pressing the material adjacent to the securing slots 26, 27. Following the pressing process carried out with the aid of this tool, the wall sections 28, 29 and the free blades 22, 23 are held to one another in a non-detachable manner by positive and non-positive fit.

The manner in which the connection is established between the modules 2, 3 and 4, is explained here by way of example on the basis of the enlarged sectional representation in FIG. 2 for the connection between the module 2 and the module 4 in the area of the securing slot 17. The connections in the area of the securing slots 18, 26 and 27 are produced in a corresponding manner.

Already during prefabrication of the steel sheet element 5 of the module 4, the securing slot 17 is formed into the surfaces of the cropped section 15 allocated to the module 2. The width of the securing slot 17 corresponded in this situation to the thickness D of the peripheral area 19a of the wall 19 of the module 2, to which the securing slot 17 is allocated.

In order to provide a non-detachable connection with positive and non-positive fit of the wall 19 of the module 2 to the steel sheet element 21 of the module 4, after joining the modules 2, 4, the material of the section 15 present on both sides of the securing slot 17 is pressed by means of a tool, in the manner inherently known from EP 0 868 237 B1, against the peripheral section 19a of the wall 19 located in the securing slot 17. The grooves 30, 31 formed as a result of pressing of the material on both sides of the securing slot 17 are represented in FIG. 2 in an unrealistic magnified way, for clarity.

### REFERENCE NUMBERS

1 Motor vehicle body
2,3,4 Modules
5 A-column
6 Sills
7 Front roof column of motor vehicle body 1
8 Roof carrier of motor vehicle body 1
9 B-column of motor vehicle body 1
10 C-column 10 of motor vehicle body 1
11 Plastic surface element
12 Steel sheet part
13,14 Blades of steel sheet part 12
15,16 Cropped sections
17,18 Securing slots
19,20 Wall sections
19a Free peripheral area 19a of wall section 19
21 Steel sheet element
22,23 Blades of steel sheet element
24,25 Cropped sections
26,27 Securing slot
28,29 Wall sections
30,31 Grooves
Z1,Z2 Guide channels

1. Motor vehicle body, which is composed of at least two prefabricated modules wherein, the at least two prefabricated modules are connected to one another in a non-detachable manner in a joint zone, such that a sheet of one of the at least two prefabricated modules coming into contact in the joint zone on a sheet section of another module of the at least two prefabricated modules are joined to one another in a joining process, in which at least one of the sheet sections has been cold-formed, with positive and/or non-positive fit, and in that in at least one of the modules an access channel is formed, extending at least in sections along the joint zone and accessible from outside for introduction of a joining tool.

2. Motor vehicle body according to claim 1, wherein the joint zone and the access channel extending along it are designed as a straight line.

3. Motor vehicle body according to claim 1, wherein a first module of the at least two prefabricated modules consists, at least in its section coming directly into contact with a second module of the at least two prefabricated modules of a material which belongs to another material class than that of a portion of the second module with which it comes into contact.

4. Motor vehicle body according to claim 3, wherein the first module consists of a lightweight metal material.

5. Motor vehicle body according to claim 3, wherein the first module consists of a plastic material.

6. Motor vehicle body according to claim 3, wherein the second module is manufactured in each case from a steel material.

7. Motor vehicle body according to claim 1, wherein the positive and non-positive connection between the sheet sections is formed in such a way that a peripheral section of a first module of the at least two prefabricated modules is placed in a securing slot formed into a second module of the at least two prefabricated modules and is held in the securing slot in positive and/or non-positive fit by means of material of the second module pressed laterally onto the peripheral section of the first module placed in the securing slot.

8. Motor vehicle body according to claim 7, wherein at least a section of the second module, into which the securing slot is formed, consists of a metal material.

9. Motor vehicle body according to claim 8, wherein the metal material is a steel material.

10. Motor vehicle body according to claim 7, wherein the peripheral section of the first module placed in the securing slot is aligned essentially perpendicular to the surface of the section (15, 16, 24, 25) of the second module, into which the securing slot is formed.

11. Motor vehicle body according to claim 7, wherein the at least two prefabricated modules, after joining in the area of the joint zone, form a hollow profile representing the access channel, which is delimited at the sides by at least two mutually opposing walls, of which in each case a part is allocated to the second module and has a cropped peripheral section, in the surface of which, allocated to the first module, the securing slot is formed, while the other part of the walls in each case is allocated to the first module and is held by its peripheral section in the securing slot.

12. Method for manufacturing a motor vehicle body comprising the following production steps:
a) Prefabrication of at least two modules including formation of sheet sections allocated to another of the at least two modules in the joint zone,
b) Alignment of the at least two modules in such a way that the sheet sections allocated to another of the at least two modules abut on one another in the joint zone, and
c) Cold-forming of at least one of the sheet sections abutting on one another, in which the cold-forming takes place in a joint zone formed in an access channel freely accessible from outside, in such a way that the sheet sections are connected to one another after cold-forming in a non-detachable manner in positive and/or non-positive fit.

13. Method according to claim 12, wherein in:
the production step a) comprises formation of a strip-like freely projecting peripheral section on a first module of the at least two modules and a securing slot on a sheet section of a second module of the at least two modules, the course of the peripheral section is adapted to the course and shape of the securing slot,
the production step b) comprises the insertion of the peripheral section of the first module into the securing slot of the second module, and
the production step c) comprises the pressing of material of the second module, laterally adjacent to the securing slot against the peripheral section of the first module located in the securing slot, such that the first and second modules are connected to one another in a non-detachable manner in non-positive and/or positive fit at least over specific longitudinal sections of the securing slot.

14. Method according to claim 13, wherein with production step c) forces required for pressing the material of the second module against the peripheral section of the first module are applied by means of two pressure rollers moved along the securing slot, one of which in each case is guided on one of the sides of the securing slot and at a distance from it.

15. Method according to claim 12, wherein in production step c) the cold-forming process is carried out as a peripheral flanging process.
